(19) United States
(12) Patent Application Publication
(10) Pub. No.: US 2010/0080531 A1
(43) Pub. Date: Apr. 1, 2010

(54) VIDEO TELOP SELECTION APPARATUS AND METHOD

(75) Inventors: Nayuko Watanabe, Yokohama-shi (JP); Masaru Suzuki, Kawasaki-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/561,673

(22) Filed: Sep. 17, 2009

(30) Foreign Application Priority Data
Sep. 26, 2008 (JP) 2008-248662

(51) Int. Cl. H04N 5/91; G06K 9/00; G06F 17/30

(52) U.S. Cl. 386/95; 382/181; 707/748; 707/769; 707/E17.002; 707/E17.014

(57) ABSTRACT

A video telop selection apparatus includes a video playback unit which plays back a video, a determination unit which determines appearance positions of telops and appearance intervals of the telops, a frame storage unit which stores frames containing the telops, an index generating unit which generates telop indices having the appearance positions of the telops and the appearance intervals of the telops, an index storage unit which stores the telop indices, an index selection unit which selects a telop index for a preferential telop from the telop indices, wherein the preferential telop is a telop that is given a priority based on an appearance position of the telop and an appearance interval of the telop, and an index display unit which generates an index selection frame, based on the telop index for the preferential telop and a frame containing the preferential telop, and displays the index selection frame.

### CROSS-REFERENCE TO RELATED APPLICATIONS

This application is based upon and claims the benefit of priority from prior Japanese Patent Application No. 2008-248662, filed Sep. 26, 2008, the entire contents of which are incorporated herein by reference.

### BACKGROUND OF THE INVENTION

1. Field of the Invention

The present invention relates to a video telop selection apparatus for selecting a telop in a video.

2. Description of the Related Art

There are demands from viewers to search the Web or the like for information using keywords in which they are interested while viewing a video. Some keywords contained in telops displayed on the screen during playback of a video, in particular, tend to impress viewers. Presently, in order to satisfy such demands, it is necessary to activate a Web browser during viewing and search for information by typing a keyword appearing in a telop with a keyboard.

Inputting a keyword to a Web browser using a keyboard or the like for search is troublesome operation. This is conspicuous especially in the case of video equipment with a poor input device, e.g., a TV set. In addition, telops change with time. When, therefore, a telop disappears, the viewer cannot recall the accurate expression, and hence cannot find pertinent information. In the case of an unrecorded video, when a telop changes, the viewer cannot perform search. Even in the case of a recorded video, the viewer needs to perform search by pausing the video and reading a telop.

As a solution method that has been used, there is known a method of presenting a viewer a list of keywords upon telop recognition and supporting keyword entry when the viewer selects a keyword of interest from the list (e.g., www.hitachi.co.jp/rd/pdf/topics/hitac2008_{—}07_crl.pdf).

According to the method of presenting a list of keywords upon telop recognition, since the appearance position information of a telop is lost, the viewer must select again, from the list, a keyword that he/she has seen once, resulting in troublesome operation.

### BRIEF SUMMARY OF THE INVENTION

According to one aspect of the present invention, a video telop selection apparatus includes a video playback unit which plays back a video; a determination unit which determines appearance positions of a plurality of telops appearing during playback of the video and appearance intervals of the telops; a frame storage unit which stores a plurality of frames containing the telops; an index generating unit which generates a plurality of telop indices having the appearance positions of the telops and the appearance intervals of the telops; an index storage unit which stores the telop indices; an index selection unit which selects a telop index for a preferential telop from the telop indices stored in the index storage unit, wherein the preferential telop is a telop that is given a priority based on an appearance position of the telop and an appearance interval of the telop; and an index display unit which generates an index selection frame, based on the telop index for the preferential telop and a frame containing the preferential telop which is stored in the frame storage unit, and displays the index selection frame.

### BRIEF DESCRIPTION OF THE SEVERAL VIEWS OF THE DRAWING

FIG. 1 is a block diagram showing a video telop selection apparatus according to the first embodiment;

FIG. 2 is a view showing an example of a remote controller;

FIG. 3A is a view showing an example of a video;

FIG. 3B is a view showing an example of telop indices;

FIG. 4 is a view showing an example of telop indices before index selection/deletion processing;

FIG. 5 is a view showing telop indices as intervals;

FIG. 6 is a view showing an example of intervals set by delimiting the intervals of telop indices with the start and end times of the telops;

FIG. 7A is a view showing an interval/telop table;

FIG. 7B is a view showing a use interval table;

FIG. 7C is a view showing a use interval result;

FIG. 8 is a view showing the intervals of telop indices selected as a result of index selection/deletion processing;

FIG. 9 is a flowchart for index selection/deletion processing;

FIG. 10 is a flowchart showing preferential telop selection processing during index selection/deletion processing;

FIG. 11 is a view showing an example of telop indices selected as a result of index selection/deletion processing;

FIGS. 12A and 12B are views showing an example of extraction of index frames from selected telop indices;

FIG. 13A is a view showing an example of a default index frame;

FIG. 13B is a view showing an example of an index selection frame preceding the default frame by one frame;

FIG. 13C is a view showing an example of an index selection frame preceding the default frame by two frames;

FIG. 14 is a view showing an example of telop selection frames;

FIG. 15A is a view showing an example of a telop frame;

FIG. 15B is a view showing an example of extracted keywords from a telop frame;

FIG. 16 is a view showing an example of a keyword selection frame;

FIG. 17A is a view showing an example of a search menu frame;

FIG. 17B is a view showing an example of a search result frame;

FIG. 18 is a view showing an example of a semantic attribute/service dictionary which can be used for search;

FIG. 19 is a block diagram showing a video telop selection apparatus according to the second embodiment;

FIG. 20 is a view showing an example of telop indices with score fields;

FIG. 21 is a view showing an example of the result obtained by adding scores to telop indices;

FIG. 22 is a flowchart showing the processing of grouping telop indices for each time width;

FIG. 23 is a flowchart showing grouping processing performed in consideration of the overlaps of telop positions;

FIG. 24A is a view showing an example of a group list as a grouping processing result;

FIG. 24B is a view showing an interval list as a grouping processing result;

FIG. 25 is a view showing the processing of merging telop indices for each group;

FIG. 26A is a view showing an example of images before two telop indices are merged;

FIG. 26B is a view showing an example of an image after the two telop indices are merged;

FIG. 27 is a view showing an example of keywords which can be extracted from a telop and their semantic attributes;

FIG. 28 is a view showing an example of a dictionary of addition scores corresponding to semantic attributes;

FIG. 29 is a block diagram showing a video telop selection apparatus according to the fourth embodiment;

FIG. 30 is a view showing an example of telop type determination rules for a news program; and

FIG. 31 is a view showing an example of telop-type-specific extraction rules for the news program.

### DETAILED DESCRIPTION OF THE INVENTION

Video telop selection apparatuses according to various embodiments of the present invention will be described in detail below with reference to the views of the accompanying drawing. The following will describe the embodiments in which the video telop selection apparatuses are applied to the keyword search functions of video recording equipment. Note that the video telop selection apparatuses can be applied to various functions other than the keyword search functions.

### First Embodiment

The first embodiment will be described below with reference to the views of the accompanying drawing. The first embodiment exemplifies a video telop selection apparatus which extracts a frame containing a telop which is minimum necessary for the user to select a keyword from telops in a video, and allows the user to easily select a keyword in a telop on a frame by retracing the past.

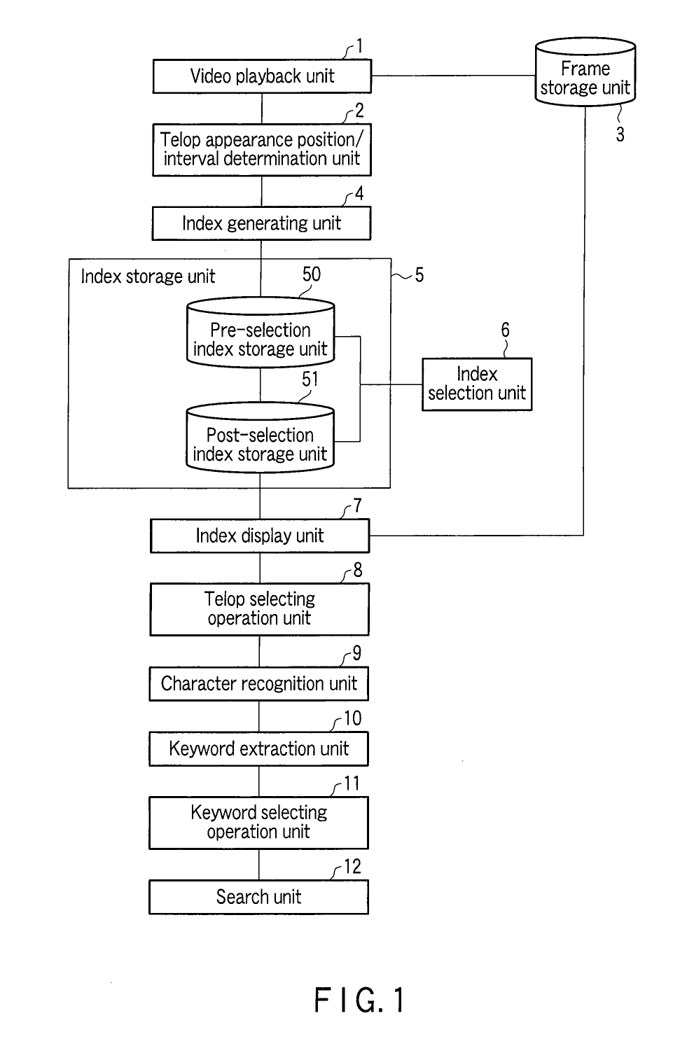

Referring to FIG. 1, the video telop selection apparatus includes a video playback unit 1 to play back a video, a telop appearance position/interval determination unit 2 to determine the position and interval of a telop appearing in a video, a frame storage unit 3 to store a frame containing a telop, an index generating unit 4 to generate a telop index based on obtained telop information, and an index storage unit 5 to store telop indices.

This apparatus also includes an index selection unit 6 to select an index, from the indices stored in the index storage unit 5, which is minimum necessary for the user to select a keyword and to further select one ore more preferential telops, an index display unit 7 to generate a telop index selection frame based on the telop index selected by the index selection unit 6 and allow the user to select the index, and a telop selecting operation unit 8 to allow the user to select a telop on an index frame after index selection.

This apparatus further includes a character recognition unit 9 to perform character recognition for the telop area selected by the user, a keyword extraction unit 10 to extract keywords from character information obtained as a result of the character recognition, a keyword selecting operation unit 11 to allow the user to select one or more keywords from the extracted keywords on the frame on which a telop has been selected, and a search unit 12 to generate a query based on the keyword finally selected by the user and perform search.

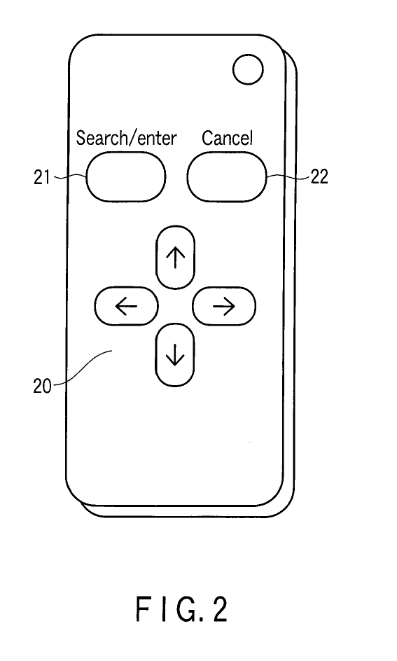

The video telop selection apparatus according to this embodiment allows a viewer to perform Web search and program search by selecting keywords from telops in a video while viewing a TV broadcast program. The video telop selection apparatus can be implemented by installing an application program for referring to the contents of a video, in a PC (Personal Computer) which allows to view videos. A PC used as the video telop selection apparatus can take any form such as a notebook PC, and can be implemented by a video viewing device, other than a PC, e.g., a TV, or a video recording device such as an HDD recorder. As an input unit for selecting a video telop, a mouse, a keyboard, or the like can be used when a PC is to be used. When a video viewing device such as a TV set is to be used, it suffices to perform at least input operation for vertical and horizontal movement (buttons 20), decision (button 21), cancellation (button 22), and the like as in the case of the remote controller shown in FIG. 2, which may be used as an operation input device for a user. Note that this embodiment will be described on the assumption that a system configured to perform operation aiming at a TV screen with a remote controller is used.

The video telop selection apparatus can perform its processing at any timings. For example, the apparatus can perform processing while the user is viewing a target program. Alternatively, the apparatus can perform processing after a target program is recorded, when the user uses the apparatus while viewing the program recorded in advance. It is also conceivable that the apparatus may perform processing step by step, e.g., automatically performing processing up to index generation and then performing subsequent processing at the time of user input.

The operation of the video telop selection apparatus shown in FIG. 1 will be described with reference to FIG. 1.

### (Extraction of Telop Information)

The telop appearance position/interval determination unit 2 determines the display position and display interval of a telop when it appears in a video. To determine when and where a telop has appeared, for example, the technique disclosed in JP-A 2005-339537 (KOKAI) can be used. This technique allows to obtain information indicating that a telop is present in a rectangle (x: x-coordinate, y: y-coordinate, w: width, h: height) of the nth frame of a video and contour information of the telop as an image. If the likelihood of a telop can be obtained at the same time, it is possible to set a given threshold and determine that given information is a telop when its likelihood is equal to or more than the threshold. In addition, it is possible to detect an interval in which a telop appears between the mth frame and the nth frame or between the mth second and nth second by comparing the similarity or the like between detected frames. The following description is based on the assumption that an appearance interval (sec) could be detected.

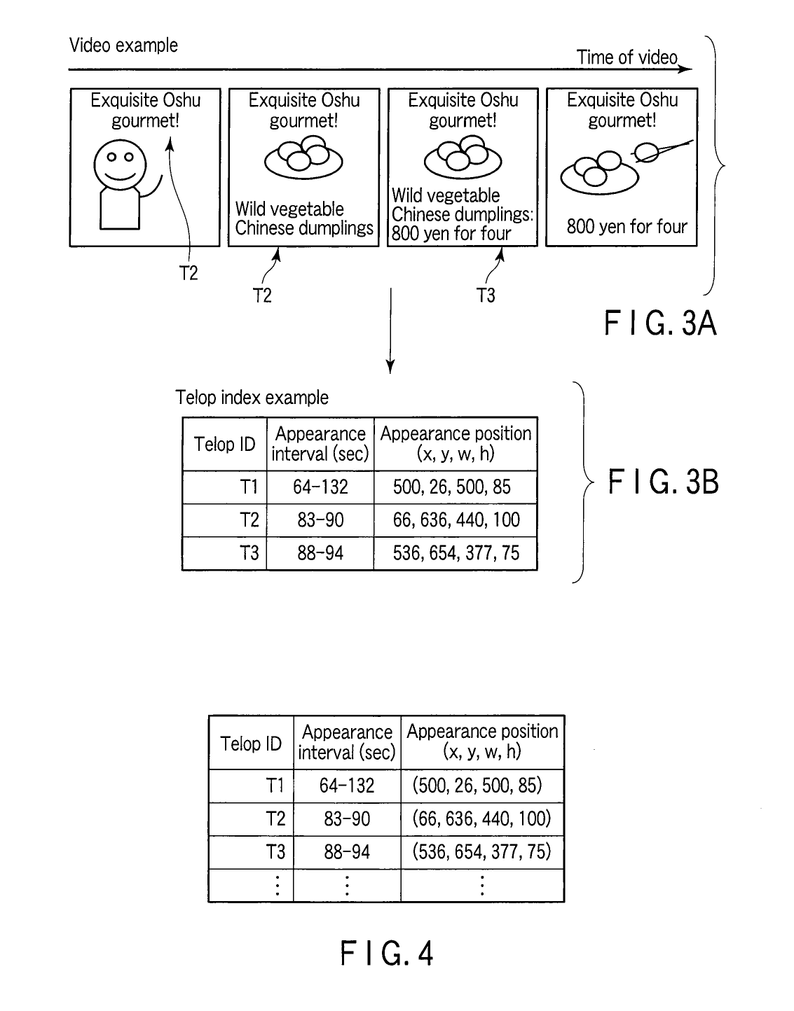

The telop appearance position/interval determination unit 2 can obtain telop indices (indicating telop appearance positions and appearance intervals for the respective telop IDs) like those shown in FIG. 3B from a video.

### (Storage of Frame Containing Telops)

The frame storage unit 3 stores a frame containing a telop. In this case, as “a frame containing a telop” it is possible to store a video itself, a still frame in which the telop has appeared, or the final frame in which the telop is displayed. Assume that a video is stored. In this case, when a still frame is required afterward, it is possible to obtain the still frame by designating a frame from the stored video. Assume that a still frame is stored. In this case, when the still frame is required afterward, the required frame is obtained by designating a still frame ID.

### (Generation of Telop Index)

The index generating unit 4 adds a telop ID (telop identifier) to each telop determined by the telop appearance position/interval determination unit 2 to generate a telop index with a combination of a telop appearance position and a telop appearance interval. In addition, a telop index may include telop contour information and pointers for still frames at the appearance start time and the appearance end time. As such pointers, it is possible to use frame information when the frame storage unit 3 is to store videos and to use frame IDs when the frame storage unit 3 is to store still frames. The index storage unit 5 includes a pre-selection index storage unit 50 to store the telop indices generated by the index generating unit 4 without any change and a post-selection index storage unit 51 to store the processing results obtained by the index selection unit 6 (to be described next). The index generating unit 4 stores generated telop indices in the pre-selection index storage unit 50.

FIG. 4 is a view showing an example of telop indices stored in the pre-selection index storage unit 50. Index IDs are added to the respective telops to form a table indicating the numbers of seconds elapsed at the start and end of each appearance interval and a rectangle representing each appearance position.

### (Selection of Telop Index)

The index selection unit 6 refers to the display intervals of the telops stored in the pre-selection index storage unit 50 to select an interval including the largest number of telops displayed so as to include all the telops, and deletes the remaining intervals.

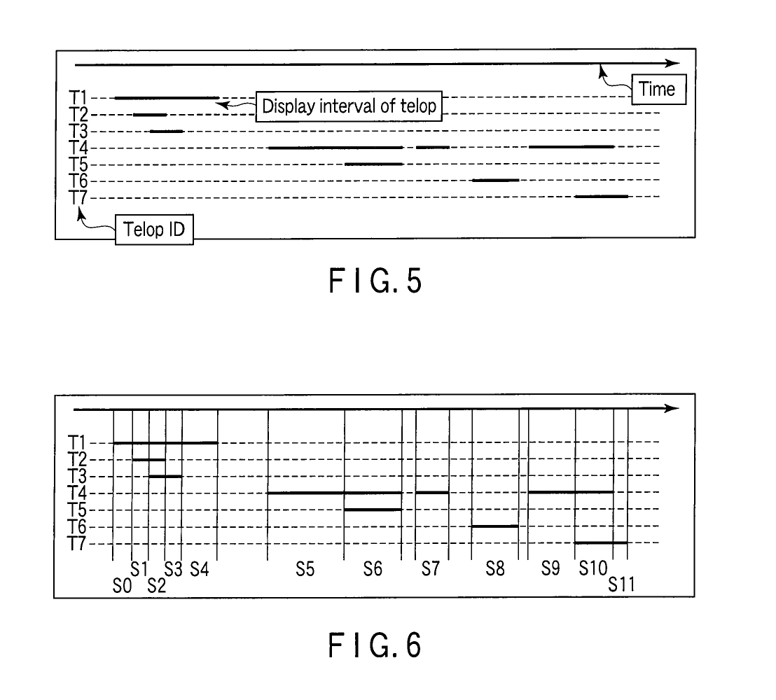

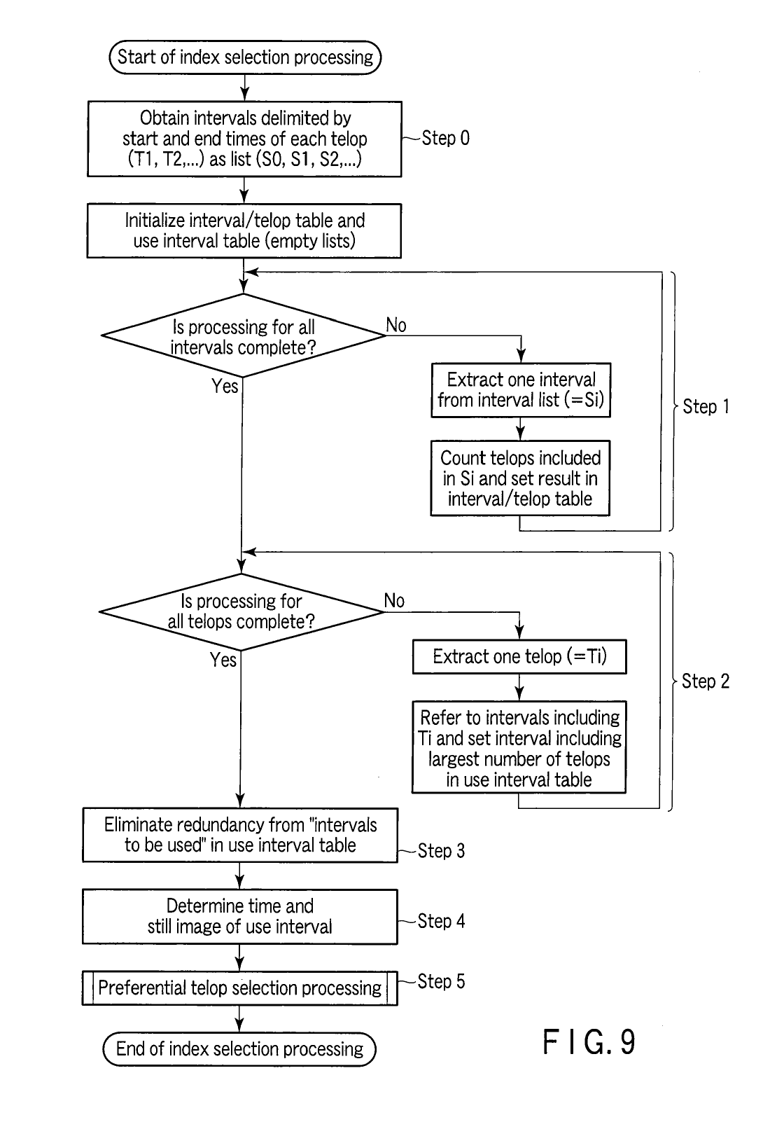

An index selection method will be described with reference to FIGS. 5 to 11. In particular, FIG. 9 is a flowchart showing index selection processing. In the following description, (step o) indicates a step in the flowchart.

First of all, the index selection unit 6 obtains intervals delimited by start times/end times of the respective telops (T1, T2, . . . ) as a list (S0, S1, S2, . . . . ) If the display intervals of the telops stored in the pre-selection index storage unit 50 are those shown in FIG. 5, the intervals delimited by the start times and end times of the respective intervals are set as intervals S0 to S11 in FIG. 6 (step 0).

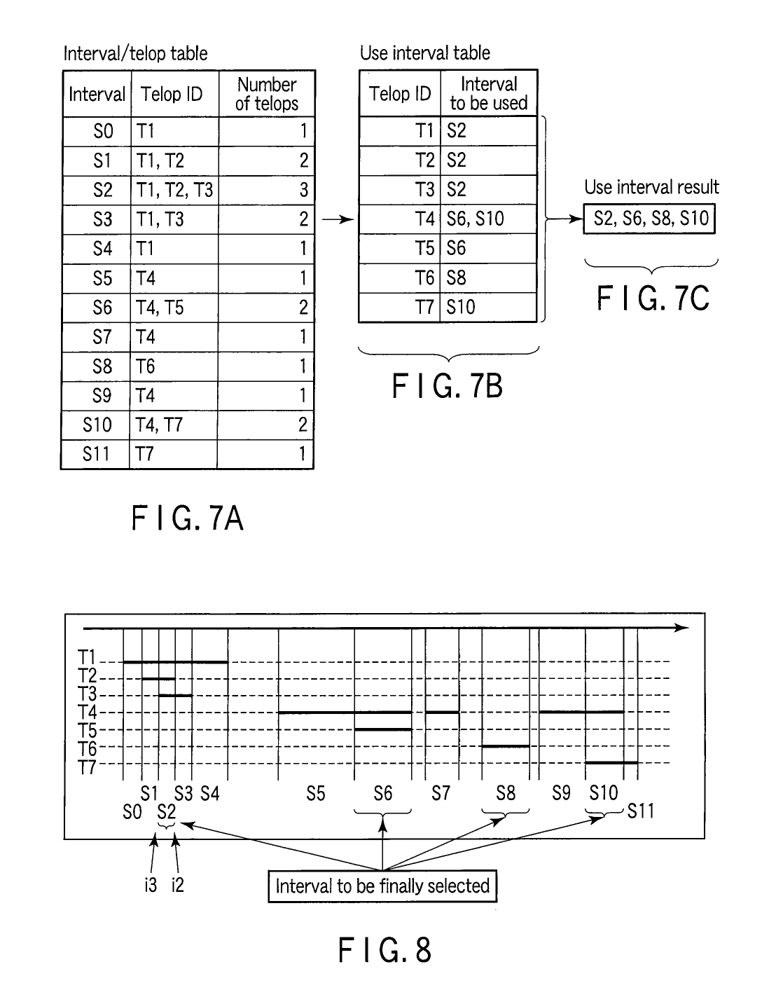

The index selection unit 6 initializes an interval/telop table and a use interval table (empties the lists), and then sequentially refers to the intervals S0 to S11 to group telops displayed in the respective intervals and add up the number of telops, thereby generating an interval/telop table (step 1). FIGS. 7A to 7C are views showing results at the respective stages of index selection/deletion processing. FIG. 7A shows the generated interval/telop table. More specifically, in step 1, the index selection unit 6 repeats the processing of extracting intervals Si from an interval list, counting telops included in the intervals Si, and setting the results in the interval/telop table until the end of processing for all the intervals.

The index selection unit 6 then refers to the interval/telop table with regard to telop IDs T0 to T7 to select, from the intervals in which telops are included in the ID list, an interval including the largest number of telops, as an interval to be used (step 2). The result becomes the use interval table shown in FIG. 7B. Consider, for example, the intervals including T1. Obviously, the intervals including T1 are intervals S0, S1, S2, S3, and S4. Of S0, S1, S2, S3, and S4, S2 includes the largest number of telops, and hence the interval to be used for T1 is S2. Likewise, with regard to T4, since both S6 and S10 include two telops, both the intervals are to be used. More specifically, in step 2, the index selection unit 6 repeats the processing of extracting telops Ti and setting an interval including the largest number of telops, in the use interval table, by referring to the intervals including the telops Ti, until the end of processing for all the telops.

Extracting intervals to be used from the use interval table in FIG. 7B while eliminating redundancy can obtain S2, S6, S8 and S10, as shown in FIG. 7C (step 3). FIG. 8 is a view showing this result represented by the telop interval list described above. The first and last still images of each of the selected intervals each correspond to the start or end of each telop. For example, the first still image of the interval S2 corresponds to an appearance start still image i3 of the telop T3, and the last still image corresponds to the appearance end still image i′2 of the telop T2. Assume that “time” of the interval S2 is the start time of T3, and “still image” is the still image i3 at the start time of T3 (step 4).

### (Preferential Telop Selection Processing)

The interval S2 includes three types of telops with the telop IDs T1 to T3. Of these telops, a preferential telop is determined based on the sizes or appearance intervals of the telops (step 5). When such a telop is to be determined from the sizes of the telops, it is possible to refer to the appearance positions of T1, T2, and T3 to select one having the largest size. When such a telop is to be determined from the appearance intervals of the telops, it is conceivable to select one having the longest appearance time or the shortest appearance time. Most preferably, a telop which hardly appears in intervals other than the interval of interest is selected as a preferential telop.

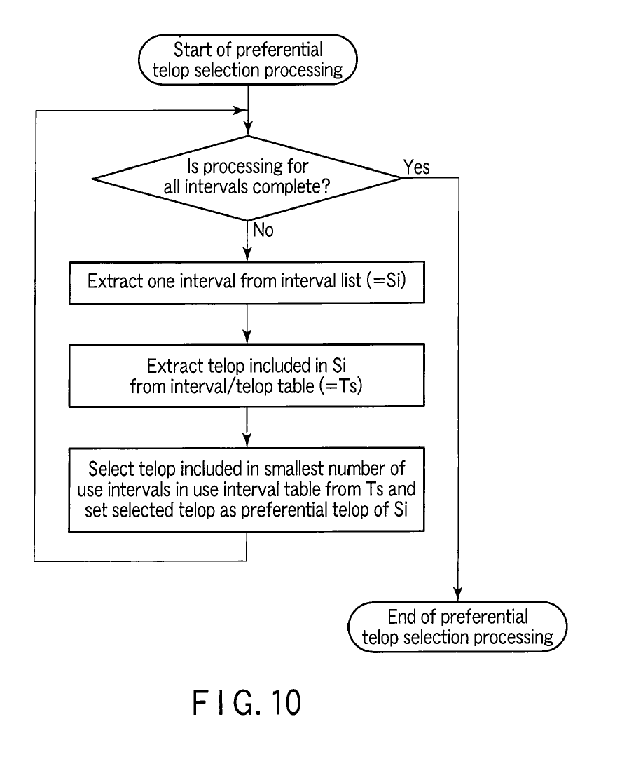

A method of selecting a telop which hardly appears in intervals other than the interval of interest by selecting one of telops which corresponds to a lower appearance frequency among selected indices will be described below by exemplifying the interval S6. FIG. 10 is a flowchart for such preferential telop selection processing. Referring to the interval/telop table in FIG. 7A, the telops included in S6 are T4 and T5. Referring to the use interval table in FIG. 7B with regard to T4 and T5, T4 is included in the two intervals S6 and S10, and T5 is included in only the interval S6. In this manner, the index selection unit 6 refers to the intervals including the respective telops to select a telop which is included in the smallest number of intervals. In this case, the index selection unit 6 selects T5 as a preferential telop. More specifically, as shown in FIG. 10, the index selection unit 6 extracts one of the intervals Si from the interval list, and extracts a plurality of telop Ts included in Si from the interval/telop table. The index selection unit 6 then selects a telop, from the telops Ts, which is included in the smallest number of use intervals in the use interval table, and sets the selected telop as a preferential telop in Si. The index selection unit 6 repeats this processing until the end of processing for all the intervals. This makes it possible to select, as a preferential telop, a telop which hardly appears in intervals other than the interval S6.

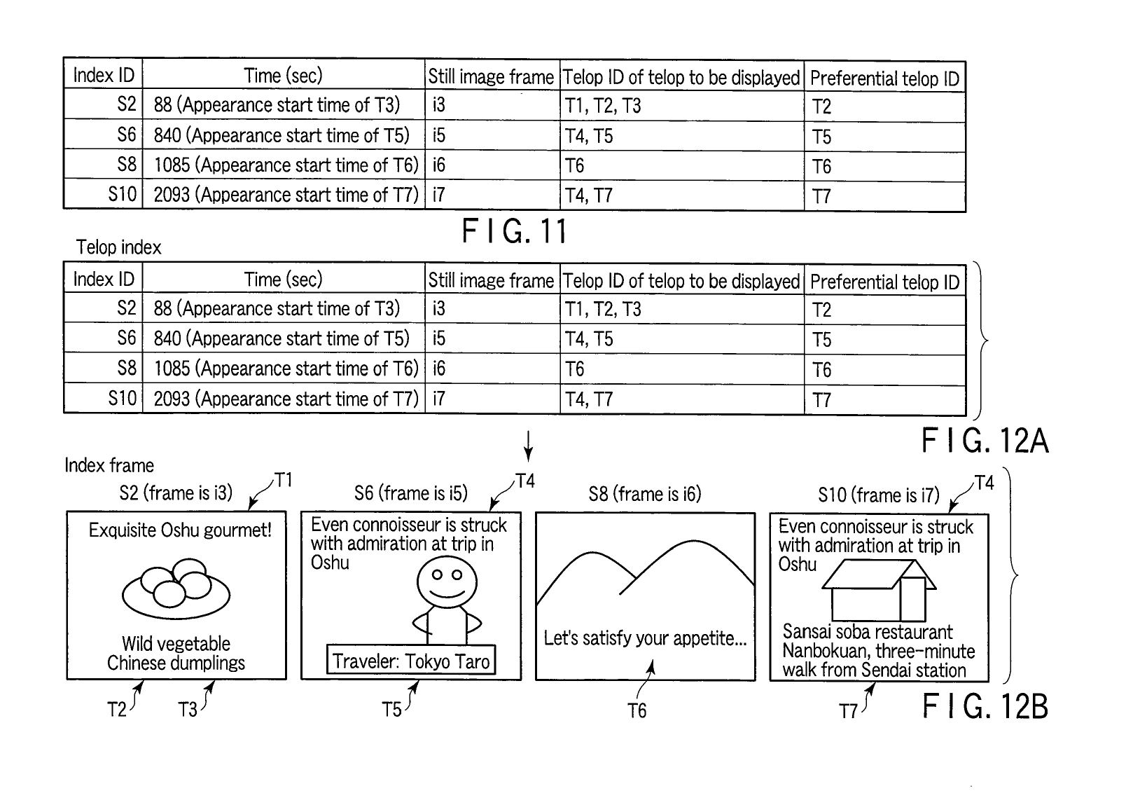

As described above, first of all, the index selection unit 6 selects only a telop interval necessary for selection by the user from the plurality of telop indices stored in the index storage unit 5. Telop indices after selection are generated from these pieces of information and are stored in the post-selection index storage unit 51. FIG. 11 shows an example of telop indices after selection which are stored. As shown in FIG. 11, the telop indices after selection are stored as a table with the intervals S2, S6, S8, and S10 being set as the index IDs of the respective telop indices and the times, still image frames, telop IDs to be displayed (the telop ID group included in the respective intervals), and preferential telop IDs determined in step 4 being fields. In this case, information stored in the still image frame fields are the IDs of the corresponding frames or the frames stored in the frame storage unit 3.

Index selection frame generation and keyword selection will be described next.

### (Telop Index Selecting Operation Frame)

The index display unit 7 arranges, in chronological order, the index frames selected by the index selection unit 6 to allow the user to select a specific scene. For example, the index frames shown in FIG. 12B are obtained from the telop indices shown in FIG. 12A.

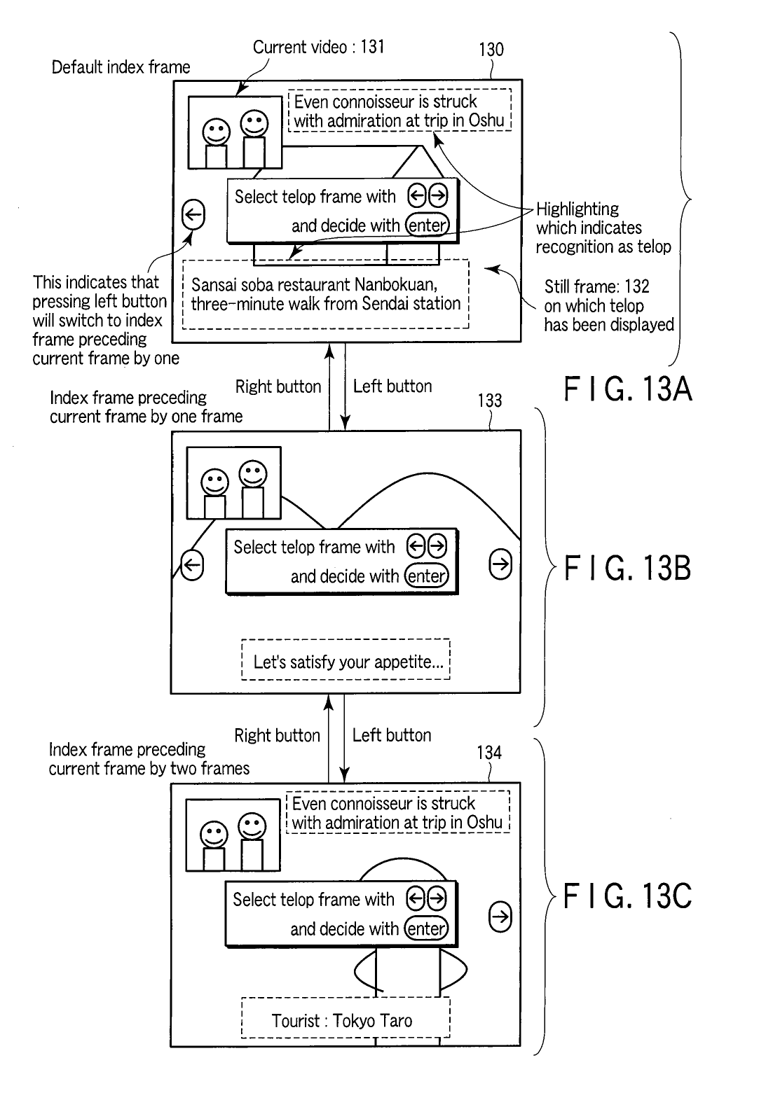

When the user (viewer) presses a button of the remote controller (FIG. 2: the enter button 21) while viewing a TV program, the current frame switches to an index frame 130 shown in FIG. 13A. A video 131 of the currently viewed program is displayed on the upper left portion, and a still frame 132 of the latest indices of the index group after index selection processing is displayed on the entire screen. At this time, each area recognized as a telop is displayed in a highlighted state (the state enclosed by the dotted line in the example shown in FIG. 13A). The still frame is acquired from the frame storage unit 3. When the user presses the left button (FIG. 2: left button 20) in this state, an index frame 133 shown in FIG. 13B which precedes the current frame by one frame is displayed. When the user further presses the left button (FIG. 2: left button 20), an index frame 134 shown in FIG. 13C which precedes the current frame by two frames is displayed. When the user presses the enter button (FIG. 2: enter button 21), the corresponding frame is selected, and the frame shifts to a telop selection frame. The user can select an index frame by pressing the left and right buttons in this manner.

### (Telop Selecting Operation Frame)

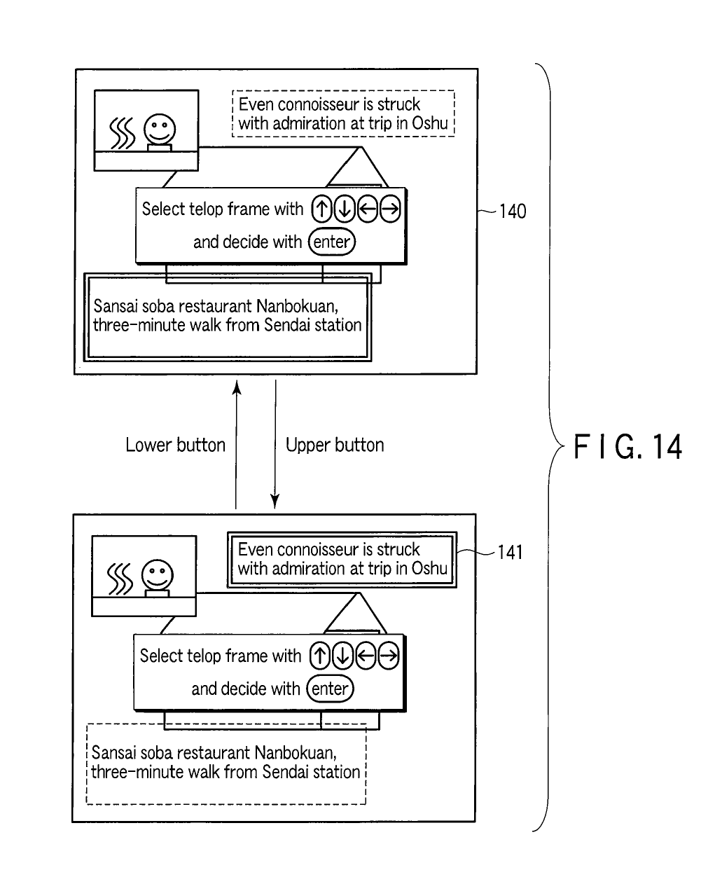

The telop selecting operation unit 8 allows the user to select, on the index frame selected by the user, a telop on the frame. In this case, the default frame indicates that the preferential telop determined by the index selection unit 6 is in a selected state. FIG. 14 shows an example of a telop selection frame. A default frame 140 is displayed on the upper portion in FIG. 14. When the user presses the upper button 20 in this state, a telop 141 positioned at the upper portion is selected as indicated by the view on the lower portion in FIG. 14. When the user presses the enter button 21, the selection is determined (confirmed).

### (Character Recognition)

The character recognition unit 9 performs character recognition for the telop area selected on the telop selection frame by the user and extracts a telop character string. Since the telop appearance position/interval determination unit 2 has also obtained the contour information of the telop image, it is possible to use various conventional OCR (Optical Character Recognition) techniques for character recognition.

### (Keyword Extraction)

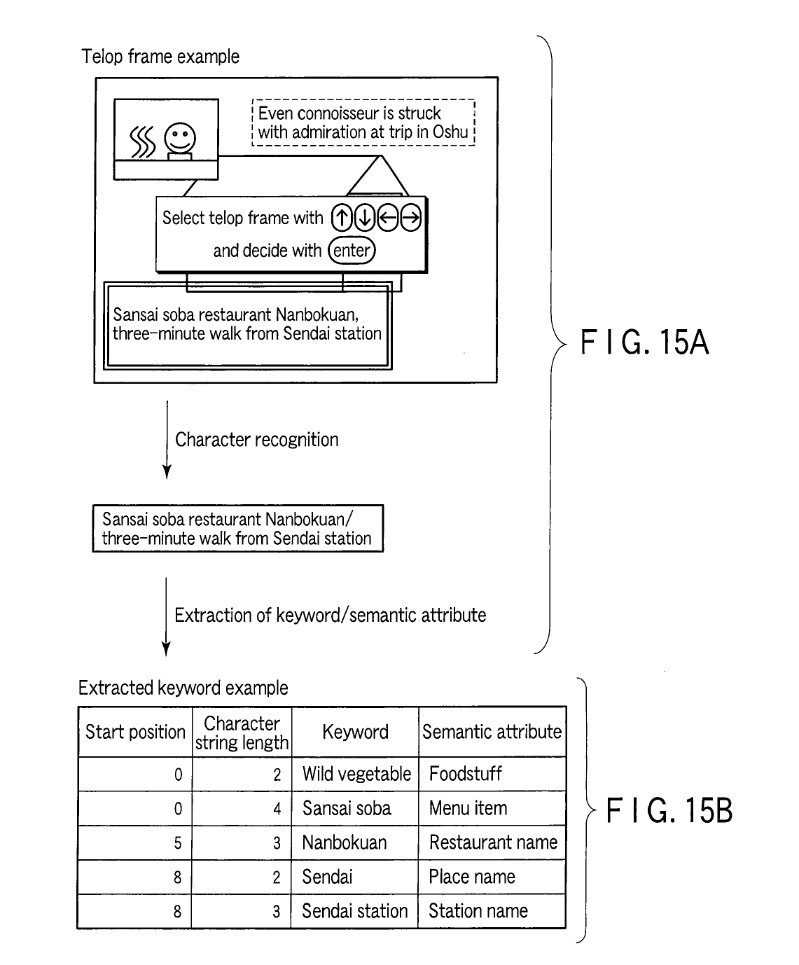

The keyword extraction unit 10 extracts keywords in the telop character string extracted by the character recognition unit 9. As a means for extracting keywords, a method of extracting noun phrases by using an existing technique such as morphological analysis can be used. In addition, the semantic attributes of keywords can be determined by using a known named entity extraction technique (e.g., reference: Yumi Ichimura et al., “A Study of the Relations among Question Answering, Japanese Named Entity Extraction, and Named Entity Taxonomy”, Research Report on Information Processing Society of Japan, NL-161-3, 2004″). For example, it is possible to extract keywords and their semantic attributes like those shown in FIG. 15B from the telop frame shown in FIG. 15A.

### (Keyword Selecting Operation Frame)

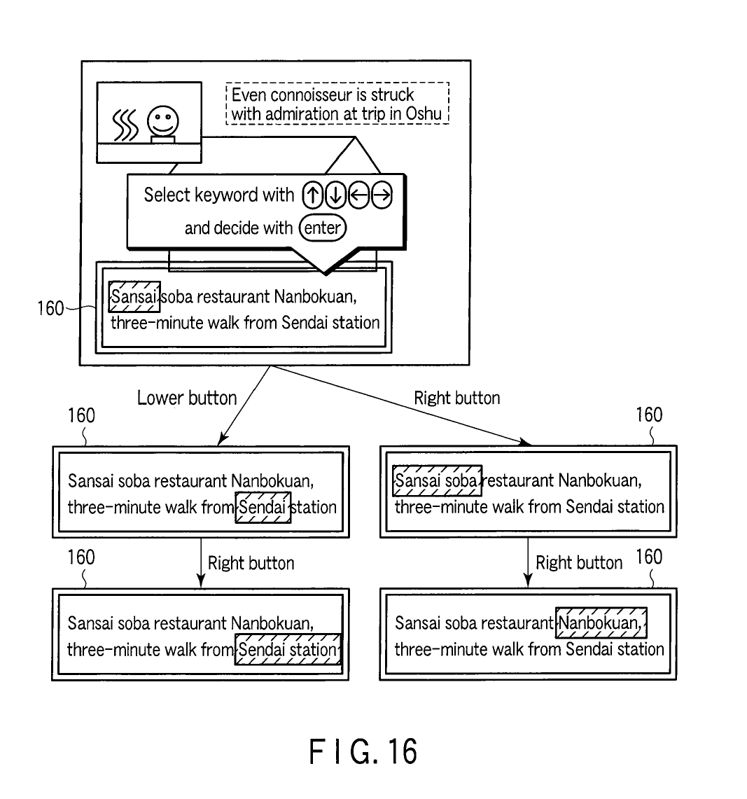

The keyword selecting operation unit 11 allows the user to select one of the keywords extracted from the telop, selected on the telop selection frame by the user, by the keyword extraction unit 10 on the frame. As shown in FIG. 16, when a keyword selection frame 160 is in the initial state, a portion of the telop selected by the user which corresponds to one keyword is displayed in highlighted video. This represents a cursor. The user can switch selection keywords by pressing the upper, lower, left, and right buttons 20. It is also possible to superimpose and display a character recognition result on the corresponding portion and highlight the character instead of directly highlighting the image.

### (Search)

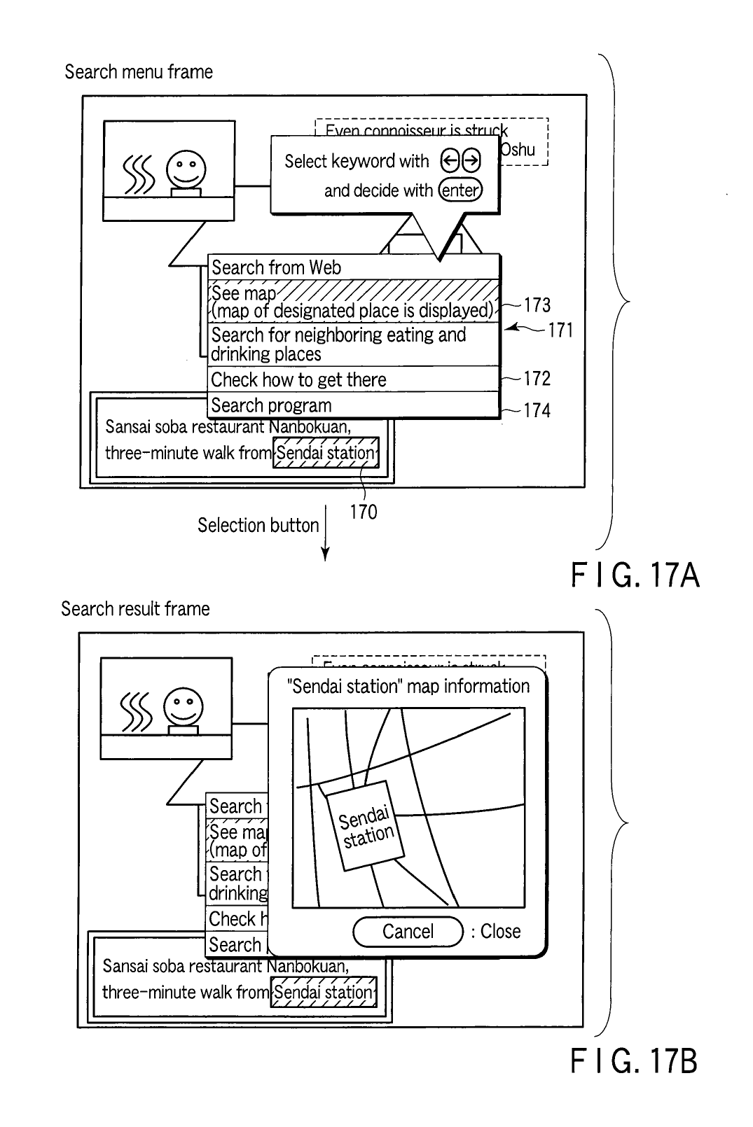

The search unit 12 performs Web search or program search based on the keywords selected on a keyword selection frame by the user. This operation can be implemented in the form of transferring keywords to a conventional Web service or a program search function in the apparatus. FIGS. 17A and 17B show an example of frames in search. When the user presses the enter button 21 upon positioning the cursor to a specific keyword 170 on the keyword selection frame which the user desires, an available action menu 171 is presented near the keyword 170.

### (Web Search)

Using a dictionary of search menus corresponding to semantic attributes can display a search menu corresponding to the semantic attribute of a designated keyword. For example, referring to FIG. 17A, since “Sendai station” is designated as the keyword 170, a menu item “check how to get there” 172 and the like corresponding to the semantic attribute “station name” of “Sendai station” are displayed. FIG. 17A shows an example of a frame indicating a state in which the user presses the upper and lower buttons 20 to position the cursor to “see map” 173. When the user presses the enter button 21 in this state, the search result is displayed, as shown in FIG. 17B.

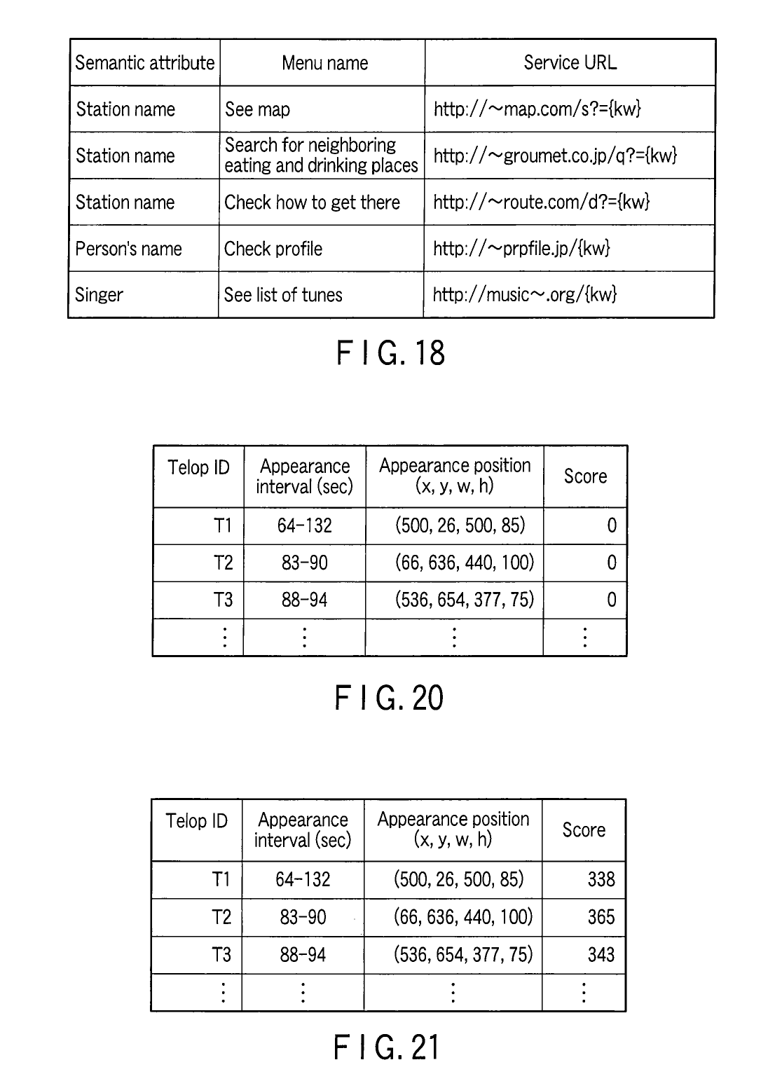

FIG. 18 shows a dictionary of search menus and actual service URLs which correspond to semantic attributes. If the semantic attribute of a selected keyword matches a “semantic attribute” field in the dictionary, a “menu name” field is displayed in the search menu. If the user actually selects “see map”, Web access is performed by replacing the corresponding portion “{kw}” of “service URL” with the information obtained by encoding the selected keyword “Sendai station”. This makes it possible to implement the Web search function.

### (Search Within Apparatus (e.g., Program Table Search/Recorded Program Search))

A “program search” item 174 is displayed on the lower portion of the action menu 171 in FIG. 17A. Selecting this item can search a program table and recorded programs for a program having the designated keyword contained in an EPG. It is also possible to store the keywords in telops in recorded programs so as to allow to search for a program having a designated keyword contained in a telop.

According to the first embodiment described above, only minimum necessary telops are set as indices and are presented in a state in which a telop which the user can easily select is selected. This allows the user to intuitively and easily select keywords on a frame by retracing the past, thus shortening the time required for keyword selection.

### Second Embodiment

The second embodiment will be described below centered on differences from the first embodiment. The second embodiment will exemplify a video telop selection apparatus which adds scores to indices in index selection processing, and selects an index frame with the highest score for each time width while displaying other telops upon superimposing them, thereby further saving the user from the trouble of selecting telops as compared with the first embodiment.

FIG. 19 is a block diagram showing a video telop selection apparatus according to the second embodiment. The video telop selection apparatus shown in FIG. 19 is characterized by including an index score addition unit 13 to add scores to telop indices according to the degrees of change in the size/color/video of telops and an index merging unit 14 to merge indices in place of the index selection unit 6, in addition to the arrangement of the first embodiment.

### (Addition of Scores to Telop Indices)

The index score addition unit 13 extracts a telop index stored in an index storage unit 5 and adds a score to the telop index in accordance with the size and position of the telop. FIG. 20 shows an example of telop indices before the addition of scores. In score addition processing, values of f(x, y, w, h) are set in all the score fields of telop indices in the index storage unit 5. For example, a large telop is likely to impress the user. A telop displayed near the center of a frame is also likely to impress the user. Note that the size of a telop is determined by h when the telop is horizontally written in a line. This can therefore set f(x, y, w, h)=α/(distance between central point of telop rectangle and screen central point)+βh. Note however that f(x, y, w, h) is not limited to this equation. If w<h holds for a telop in a line, the telop is expected to be written vertically. In this case, for example, it is possible to use the value calculated upon interchanging of w and h. In addition, the histogram of colors in an appearing rectangle allows to determine how many lines a telop has.

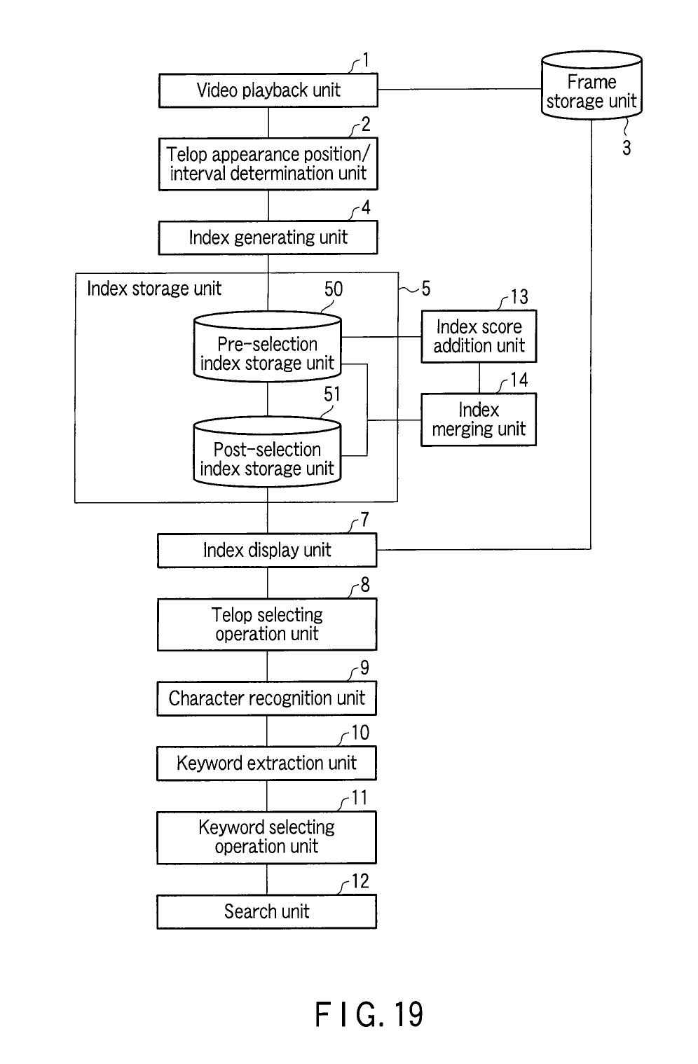

Information for determining a score is not limited to the size or position of a telop. If, for example, a telop appearance position/interval determination unit 2 determines the numbers of lines of telops, the colors of the telops, differences from the average colors of telop backgrounds, and the like and stores the results as telop indices in advance, it is possible to use them for determination. FIG. 21 is a view showing a state in which scores are added to the telop indices in FIG. 20.

### (Index Merging)

The index merging unit 14 merges telop indices, of the telop indices to which the scores are added, which are temporally close to each other. An index merging method will be described below.

### (Grouping Processing)

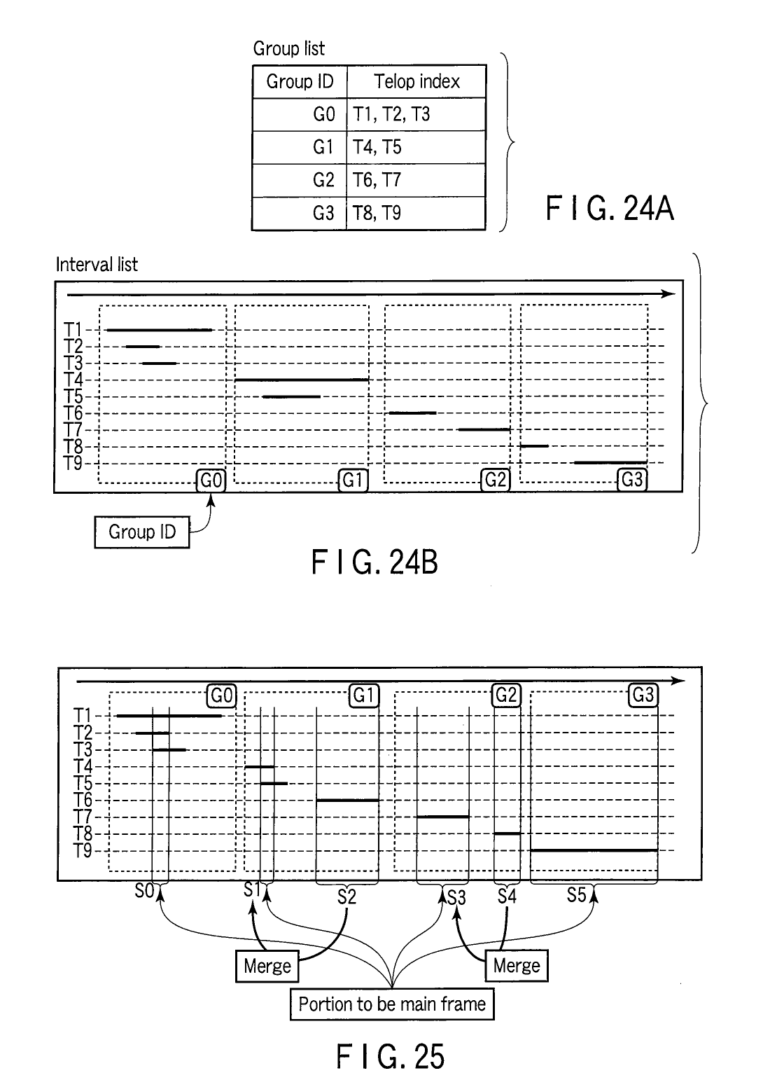

First of all, the index merging unit 14 groups indices which are temporally close to each other. This processing result is obtained as a group list. FIGS. 24A and 24B respectively show an example of a group list and corresponding intervals.

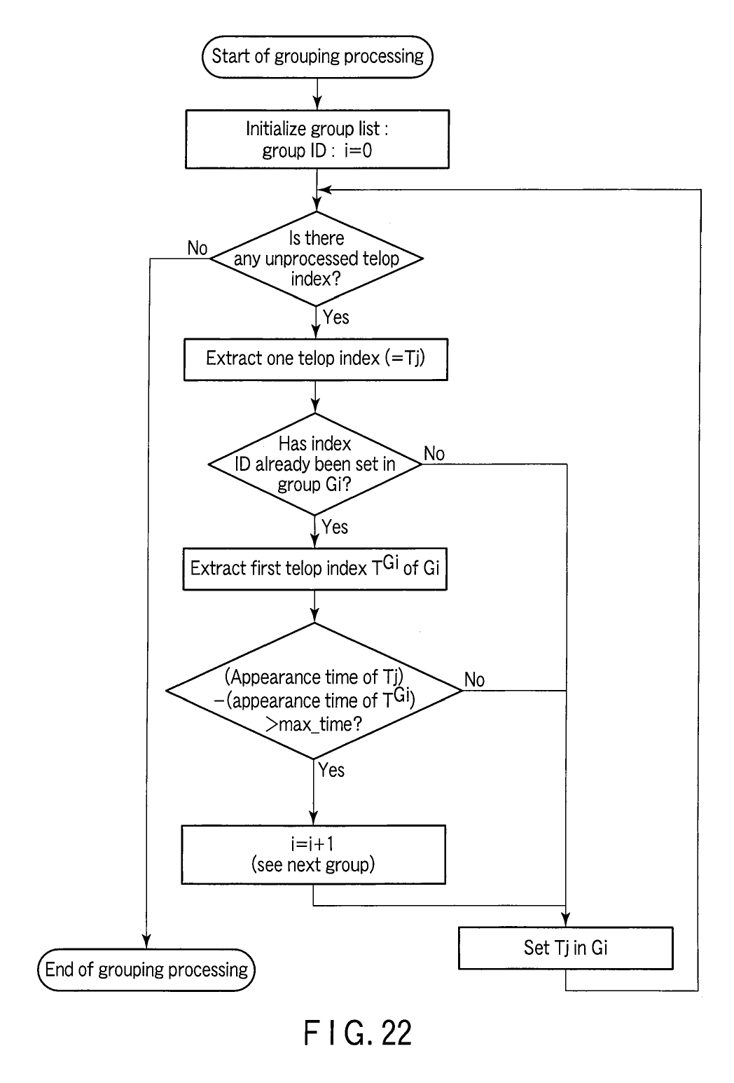

Grouping processing will be described with reference to the flowchart shown in FIG. 22.

First of all, the index merging unit 14 initializes the group list (group ID: i=0). The index merging unit 14 extracts telop indices Tj one by one and performs the following processing.

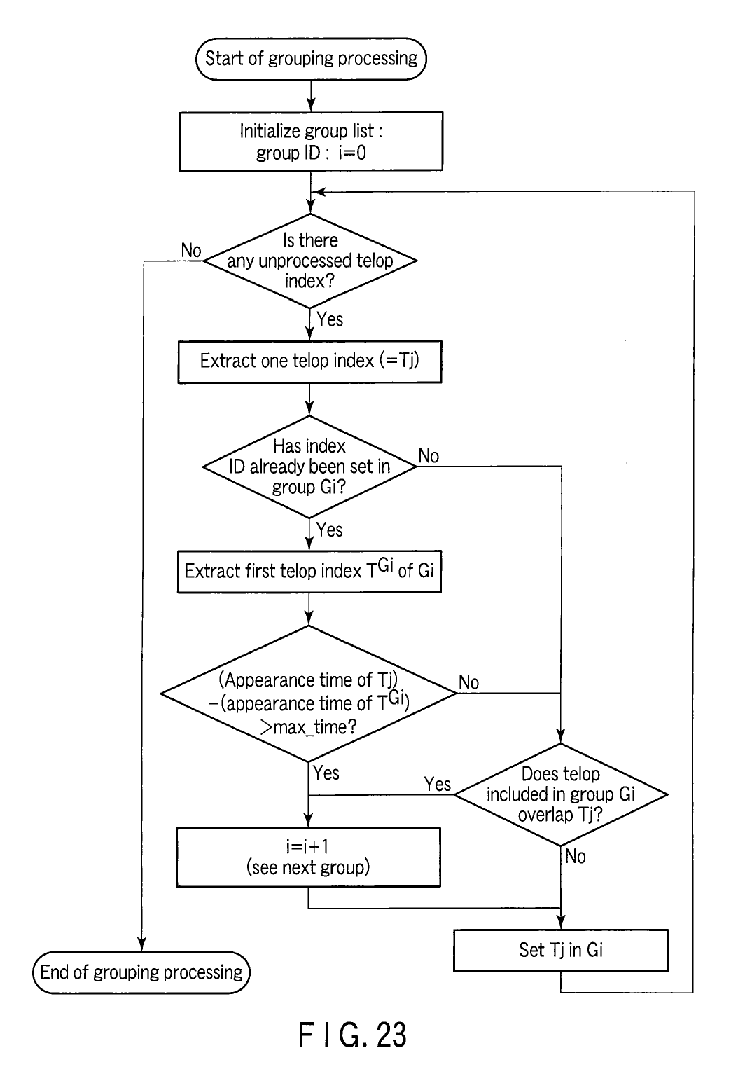

Assume that a telop index has already existed in a group Gi of interest. In this case, if the difference between the start time of the telop index and that of a first index T^{Gi} is smaller than a given threshold max_time, the telop index is set in the same group Gi. If the difference is larger than the threshold, a new group Gi+1 is created, and the telop index is set in it. In this manner, telop indices are grouped. In this case, telop indices whose appearance positions overlap may be set in different groups to prevent the telops from overlapping when telop frames are superimposed afterward. In this case, as indicated by the flowchart of FIG. 23, it suffices to insert check processing of checking whether telop indices overlap within a group.

### (Superimposition Processing)

The index merging unit 14 superimposes, on a still image of a telop index having the highest score in one group, only a telop area of a still image of a telop index other than the telop index having the highest score. This processing method will be described below by using the telop index example shown in FIG. 25.

When the index selection processing described in the first embodiment is performed for each group in FIG. 25, intervals S0 to S5 are obtained. Consider a group G0. In this case, since the interval S0 covers all telops T1 to T3 included in G0, the first still image of S0 (the still image at the start time of T3) can be used as a telop index after selection.

Consider a group G1. Of telops T4 to T6 included in G1, only T4 and T5 are covered by the interval S1. The interval S2 covers only T6. If the sum of the scores of the telop indices included in S1 is larger than that of the scores of the telop indices included in S2, only the telop appearance area of the still image at the start time of the telop index T6 included in S2 is superimposed on the first still image of S1 (the still image at the start time of T5). In this manner, if there are a plurality of intervals in a group, the scores of the respective intervals are compared with each other, and only the telop areas of the first still images of intervals other than the interval with the highest score are superimposed on the first still image of the interval with the highest score.

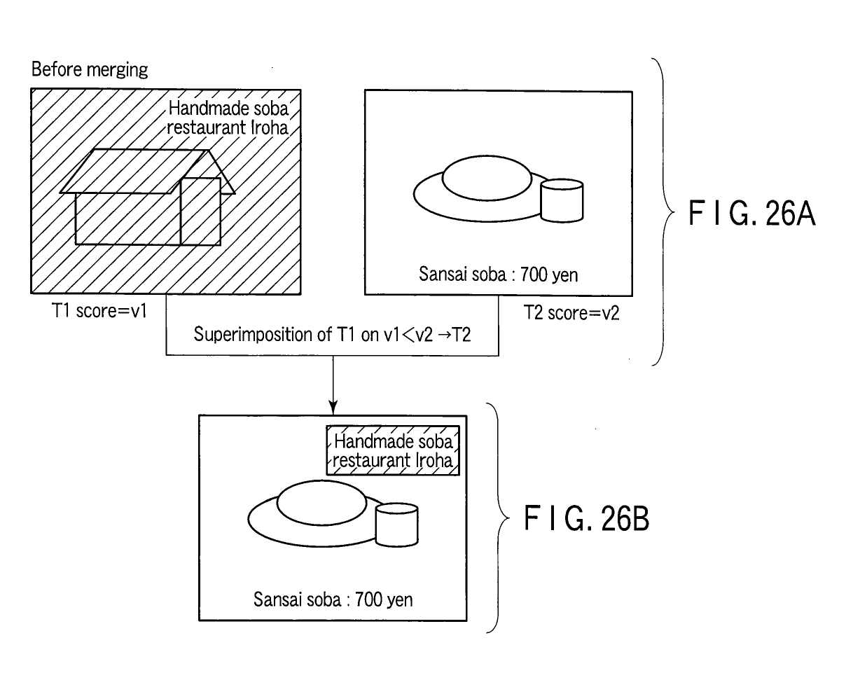

FIG. 26 shows an example of superimposing two telop indices. Assume that in this case, T1 and T2 are respectively assigned to the intervals S1 and S2. Assume also that a score v1 of T1 is low because the display time of the telop is short and the display position is at an end of the frame, and a score v2 of T2 is high because the display time of the telop is long and the display position is at the lower central portion of the frame. Merging these telop indices will obtain the frame shown in FIG. 26B. That is, only the T1 display area (the upper right portion of the frame) of the still image at the start time of T1 is superimposed on the still image at the start time of T2. Alternatively, since the respective telop indices hold the contour information of the telops, when the images are superimposed on each other, it is possible to superimpose the images cut along the contour lines.

As described above, based on telop indices in a pre-selection index storage unit 50, an index selection unit 6 generates a post-selection index such that a telop which is likely to impress the user is left unchanged, and the remaining telops are superimposed on the frame containing the telop which is likely to impress the user. As in the first embodiment, a post-selection index storage unit 51 stores the post-selection index generated in this manner. Note that a telop selecting operation unit 8 can also use the scores added to telop indices before selection to determine a default selection target. That is, the telop selecting operation unit 8 sets a telop with the highest score as a default selection target. In addition, this score information can be used to set a selection order in the telop selecting operation unit 8 (the order in which the cursor moves to telops when the user presses upper, lower, left, and right buttons 20).

The second embodiment described above adds scores to indices at the time of selection processing for the indices and selects an index frame with a high score while displaying the remaining telops upon superimposing them on the frame. This makes it possible to further save the user from the trouble of selecting telops.

### Third Embodiment

The third embodiment will be described below centered on differences from the second embodiment. The third embodiment will exemplify a video telop selection apparatus which can add scores also in consideration of the contents of character information by performing character recognition and keyword extraction, which are performed after the user selects a telop area in the second embodiment, at the time of index selection processing.

### (Addition of Scores to Telop Indices)

The third embodiment performs character recognition processing and keyword extraction processing before score addition processing in the second embodiment. The contents of each processing are the same as those described in the first embodiment.

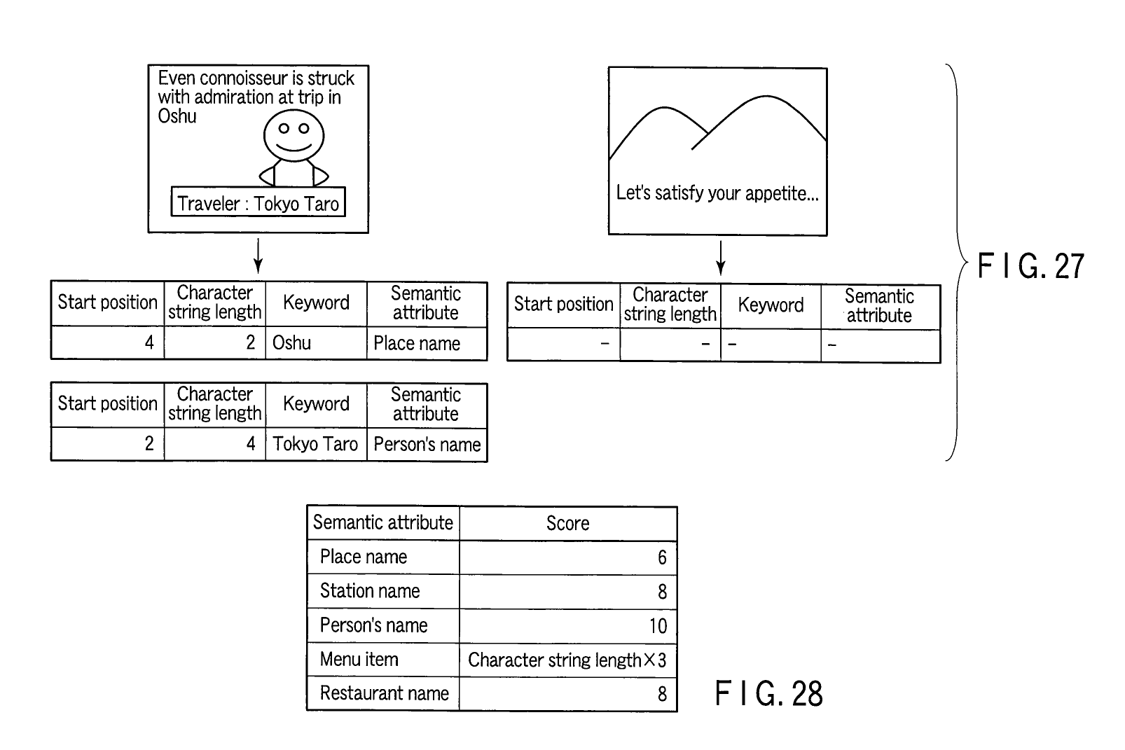

Assume that keywords and their semantic attributes could be acquired as a result of keyword extraction processing. FIG. 27 shows an example of such information. This example indicates that “Oshu (place name)” and “Tokyo Taro (person's name)” could be acquired from the respective telops on the left frame, and no keyword could be acquired from the telop on the right frame. This apparatus has a dictionary of scores corresponding to semantic attributes, and adds scores to telop indices in consideration of scores corresponding to the semantic attributes of extracted keywords. For example, the score added to the keyword “Tokyo Taro (person's name)” is 10.

The third embodiment performs character recognition for telops and adds scores in accordance with the contents of character information. This saves the user from the trouble of searching many telops for necessary information.

### Fourth Embodiment

The fourth embodiment will be described below centered on differences from the first embodiment. The fourth embodiment will exemplify a video telop selection apparatus which determines telop appearance position and interval and at the same time determines the type of telop to make it possible to use an appropriate extraction rule in accordance with the type of telop when keyword extraction is performed afterward.

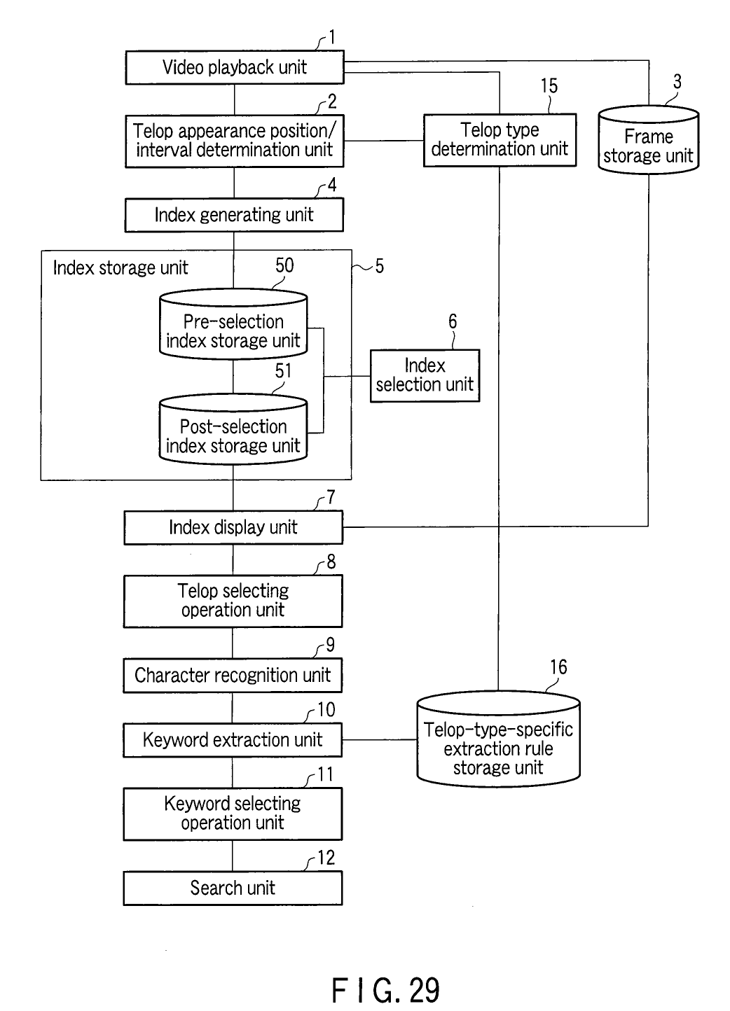

FIG. 29 is a block diagram showing a video telop selection apparatus according to the fourth embodiment.

The video telop selection apparatus shown in FIG. 29 is characterized by including a telop type determination unit 15 to determine the type of telop from the appearance position/interval of the telop and video information and a telop-type-specific extraction rule storage unit 16 to store rules for the extraction of keywords corresponding to the types of telops at the time of extraction of keywords, in addition to the arrangement of the first embodiment.

### (Telop Type Determination Unit 15)

The telop type determination unit 15 discriminates the type of telop from the meta data added to a video, the appearance position and interval of the telop, the movement of the telop, and the like. As the meta data of a video, an EPG (Electronic Program Guide), Closed Caption, and the like can be used. It is possible to use any meta data other than those named.

An example of a method of discriminating the types of telops will be described below. Assume that the telop type determination unit 15 to be described below internally has a telop type determination rule for each video genre. A video genre can be easily determined from an EPG.

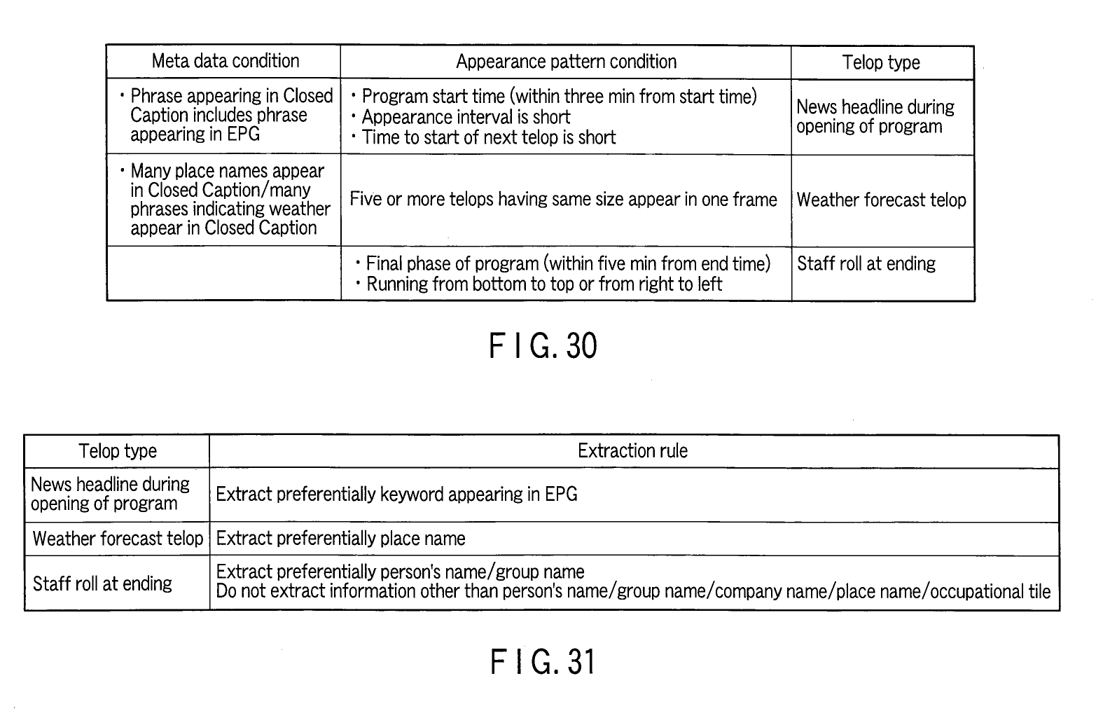

FIG. 30 shows an example of determination rules for a case in which the video genre was “news”. First of all, telops are grouped for each time width. This apparatus performs grouping processing in the same manner as that described in the second embodiment. The apparatus then refers to a telop type determination rule matching the video genre for each group to sequentially check whether the group satisfies meta data conditions and appearance pattern conditions. If the group satisfies all the conditions, the apparatus determines that the group is of the corresponding telop type. If the group does not satisfy any conditions, the apparatus may determine that the group is “other groups”. This determination result can be held in the field “telop type” formed in the telop index.

Assume that telops belonging to a telop group appearing immediately after the start of a video have short appearance intervals. If a set of keywords which have appeared as a result of keyword extraction performed for a Closed Caption at the time of this group includes keywords extracted from an EPG, this time covers all the outline of the program explained in the EPG. That is, the telop at this time can be regarded as the headline of all the news explained in the program, which is seen during the opening of the news program.

In addition, for example, a telop which appears in the final phase of a program and runs vertically or horizontally can be regarded as a “staff roll”.

### (Telop Selection Frame)

Discriminating telop types can provide a selection method in accordance with a telop type when the telop selecting operation unit 8 generates a telop selection frame. If, for example, a telop type is a staff roll, the user may press a button corresponding to the flowing direction of the staff roll to smoothly scroll it so as to select a desired portion.

### (Keyword Extraction by Telop-Type-Specific Extraction Rules)

The telop-type-specific extraction rule storage unit 16 stores rules for preferentially extracting specific keywords at the time of keyword extraction.

FIG. 31 shows an example of extraction rules to be used when the video genre is “news”. In the case of a staff roll, for example, since keywords appearing in it can be expected to be person's names, occupational titles, company names, and the like, they are preferentially extracted. This apparatus uses an extraction rule in accordance with the type determined by the telop type determination unit 15. If the type is “other telops”, the apparatus may perform regular keyword extraction without giving any priority to any specific keywords.

The fourth embodiment switches rules for keyword extraction in accordance with the type of telop, and hence can reduce keyword noise.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video telop selection apparatus comprising:
a video playback unit which plays back a video;
a determination unit which determines appearance positions of a plurality of telops appearing during playback of the video and appearance intervals of the telops;
a frame storage unit which stores a plurality of frames containing the telops;
an index generating unit which generates a plurality of telop indices having the appearance positions of the telops and the appearance intervals of the telops;
an index storage unit which stores the telop indices;
an index selection unit which selects a telop index for a preferential telop from the telop indices stored in the index storage unit, wherein the preferential telop is a telop that is given a priority based on an appearance position of the telop and an appearance interval of the telop; and
an index display unit which generates an index selection frame, based on the telop index for the preferential telop and a frame containing the preferential telop which is stored in the frame storage unit, and displays the index selection frame.

2. The apparatus according to claim 1, wherein the index selection frame includes a plurality of telop areas including a telop area for the preferential telop, and further comprising:
a telop selecting operation unit to make a user perform selecting operation for a telop area of the plurality of telop areas;
a character recognition unit which performs character recognition for the selected telop area;
a keyword extraction unit which extracts a plurality of keywords from character information obtained as a result of character recognition;
a keyword selecting operation unit to make the user perform selecting operation for a keyword of the plurality of extracted keywords; and
a search unit which generates a query based on the keyword and performs search including at least one of a Web search, program table search, and recorded program search.

3. The apparatus according to claim 1, wherein the index selection unit includes:
an index score addition unit which adds a score to a telop index in accordance with a size of a telop, a color of the telop, and degrees of change in a video; and
an index merging unit which superimposes telop areas in accordance with scores added by the index score addition unit.

4. The apparatus according to claim 3, wherein the index score addition unit includes a character recognition unit and a keyword extraction unit, and adds a score to a telop index in accordance with an extracted keyword.

5. The apparatus according to claim 1, wherein the index selection frame includes a plurality of telop areas including a telop area for the preferential telop, and further comprising:
a telop type determination unit which determines a telop type from information associated with the appearance position of the telop, the appearance interval of the telop, and the video;
a telop selecting operation unit to make the user perform selecting operation for a telop area of the plurality of telop areas;
a character recognition unit which performs character recognition for the telop area;
a telop-type-specific extraction rule storage unit which stores a rule for extracting a keyword in accordance with the telop type;
a keyword extraction unit which extracts a plurality of keywords from character information obtained as a result of character recognition in accordance with the rule;
a keyword selecting operation unit to make the user perform selecting operation for a keyword of the plurality of extracted keywords; and
a search unit which generates a query based on the keyword and performs search including at least one of a Web search, program table search, and recorded program search.

6. A video telop selection method comprising:
playing back a video;
determining appearance positions of telops appearing during playback of the video and appearance intervals of the telops;
storing a plurality of frames containing the telops in a frame storage unit;
generating a plurality of telop indices having the appearance positions of the telops and the appearance intervals of the telops;
storing the telop indices in an index storage unit;
selecting a telop index for a preferential telop from the telop indices stored in the index storage unit, wherein the preferential telop is a telop that is given a priority based on an appearance position of the telop and an appearance interval of the telop; and
generating an index selection frame, based on the telop index for the preferential telop and a frame containing the preferential telop which is stored in the frame storage unit, and displays the index selection frame.
